(19) United States
(12) Patent Application Publication
(10) Pub. No.: US 2024/0044255 A1
(43) Pub. Date: Feb. 8, 2024

(54) ASYMMETRIC HEAT TRANSFER MEMBER FILLET TO DIRECT COOLING FLOW

(71) Applicant: Raytheon Technologies Corporation, Farmington, CT (US)

(72) Inventor: Jaime G. Ghigliotty Rosado, Cabo Rojo, PR (US)

(21) Appl. No.: 17/879,220

(22) Filed: Aug. 2, 2022

(51) Int. Cl. F01D 5/18; F01D 9/04; F01D 11/24

(52) U.S. Cl. CPC F01D 5/187; F01D 9/041; F01D 11/24; F05D 2250/14; F05D 2250/231; F05D 2260/22141; F05D 2260/232

(57) ABSTRACT

A gas turbine engine component includes a body having an internal cooling passage with opposed walls and an array of heat transfer members attached to at least one of the opposed walls each with at least one fillet. There is an airflow direction through the cooling cavity such that the heat transfer members have a leading edge and a trailing edge. The at least one fillets have a leading edge and a trailing edge. A fillet portion leading edge is asymmetric relative to a fillet portion trailing edge to control an air flow direction towards downstream ones of the heat transfer members in the array. A gas turbine engine is also disclosed.

### BACKGROUND OF THE INVENTION

This application relates to heat transfer members associated with cooling passages in gas turbine engine components wherein a fillet connecting the member to a wall is asymmetric.

Gas turbine engines are known, and typically have a fan delivering air into a bypass duct as propulsion air. Air is also delivered into a compressor, and compressed air is delivered into a combustor where it is mixed with fuel and ignited. Products of this combustion pass downstream over turbine rotors, driving them to rotate.

As is known, components associated with the turbine section see products of combustion. As an example, there are rotating turbine blades, intermediate static stator vanes, and blade outer air seals which provide a seal outwardly of the rotating turbine blades. These components see very high temperatures, and thus are typically provided with cooling air.

Cooling air cavities within such turbine components are complex. Heat transfer enhancement members are included to increase the cooling effect provided by the cooling air. As an example, pedestals are provided which extend between spaced walls of a cooling channel. So called “race tracks,” are oval shaped pedestals. Also, so called “pin fins” extend from one wall toward another.

All of these heat transfer members have a fillet at a location where they connect into the wall. The fillets tend to be symmetric about a center line.

### SUMMARY OF THE INVENTION

In a featured embodiment, a gas turbine engine component includes a body having an internal cooling passage with opposed walls and an array of heat transfer members attached to at least one of the opposed walls each with at least one fillet. There is an airflow direction through the cooling cavity such that the heat transfer members have a leading edge and a trailing edge. The at least one fillets have a leading edge and a trailing edge. A fillet portion leading edge is asymmetric relative to a fillet portion trailing edge to control an air flow direction towards downstream ones of the heat transfer members in the array.

In another embodiment according to the previous embodiment, the fillet portion leading edge is relatively large compared to the fillet portion trailing edge.

In another embodiment according to any of the previous embodiments, the fillet portion leading edge is small compared to the fillet portion trailing edge.

In another embodiment according to any of the previous embodiments, the heat transfer components are attached to each of the spaced walls and there are two of the at least one fillets, and each of the two fillets having a leading edge portion which is asymmetric from a trailing edge portion.

In another embodiment according to any of the previous embodiments, the heat transfer members have a central portion intermediate the at least two fillets. The central portion has a similar cross-sectional shape to a cross-sectional shape of each of the two fillet portions.

In another embodiment according to any of the previous embodiments, the heat transfer members have a central portion intermediate the two fillets, and the central portion and the fillet portions have distinct cross-sectional shapes.

In another embodiment according to any of the previous embodiments, the two fillets are asymmetric relative to each other.

In another embodiment according to any of the previous embodiments, the heat transfer components have a leading edge of one of the at least two fillets attached to one of the at least two walls being small and a leading edge fillet portion of the other of the fillets attached to a second of the walls being relatively large. A trailing edge portion of the fillet is attached to the first of the walls being relatively large and a trailing edge portion of the second of the fillets is attached to the second of the walls being relatively small such that cooling air is directed to the second of the walls.

In another embodiment according to any of the previous embodiments, the component is a rotating turbine blade.

In another embodiment according to any of the previous embodiments, the component is a static stator vane.

In another embodiment according to any of the previous embodiments, the component is a blade outer air seal.

In another embodiment according to any of the previous embodiments, the heat transfer member is a pedestal having a cylindrical central section.

In another embodiment according to any of the previous embodiments, the heat transfer component has a central portion which is generally oval.

In another embodiment according to any of the previous embodiments, the heat transfer component is a pin fin attached to only one of the at least two wall through only one fillet.

In another featured embodiment, a gas turbine engine component includes a body having an internal cooling passage with opposed walls and a heat transfer member attached to at least one of the opposed walls at a fillet. There is an airflow direction through the cooling cavity such that the heat transfer member has a leading edge and a trailing edge. The at least one fillet has a leading edge and a trailing edge. A fillet portion leading edge is asymmetric relative to a fillet portion trailing edge. The heat transfer components are attached to each of the spaced walls and there are two of the at least one fillets. Each of the two fillets have a leading edge portion which is asymmetric from a trailing edge portion. The two fillets are asymmetric relative to each other. The heat transfer components have a leading edge of one of the at least two fillets attached to one of the at least two walls being small and a leading edge fillet portion of the other of the fillets attached to a second of the walls being relatively large. A trailing edge portion of the fillet is attached to the first of the walls being relatively large and a trailing edge portion of the second of the fillets is attached to the second of the walls being relatively small such that cooling air is directed to the second of the walls.

In another embodiment according to any of the previous embodiments, the heat transfer members have a central portion intermediate the at least two fillets. The central portion has a similar cross-sectional shape to a cross-sectional shape of each of the two fillet portions.

In another embodiment according to any of the previous embodiments, the heat transfer members have a central portion intermediate the two fillets. The control portion and the fillet portions have distinct cross-sectional shapes.

In another featured embodiment, a gas turbine engine includes a compressor section delivering compressed air into a combustor. The combustor is configured to mix fuel with compressed air and ignite the mixture. Products of the combustion are configured to pass over a turbine section. The turbine section includes a plurality of components with at least one of the components being provided. A gas turbine engine component includes a body having an internal cooling passage with opposed walls and an array of heat transfer members attached to at least one of the opposed walls each with at least one fillet. There is an airflow direction through the cooling cavity such that the heat transfer members have a leading edge and a trailing edge. The at least one fillets having a leading edge and a trailing edge. A fillet portion leading edge is asymmetric relative to a fillet portion trailing edge to control an air flow direction towards downstream ones of the heat transfer members in the array.

In another embodiment according to any of the previous embodiments, the heat transfer components are attached to each of the spaced walls and there are two of the at least one fillets. Each of the two fillets have a leading edge portion which is asymmetric from a trailing edge portion. The two fillets are asymmetric relative to each other.

In another embodiment according to any of the previous embodiments, the heat transfer components have a leading edge of one of the at least two fillets attached to one of the at least two walls being small and a leading edge fillet portion of the other of the fillets attached to a second of the walls being relatively large. A trailing edge portion of the fillet is attached to the first of the walls being relatively large and a trailing edge portion of the second of the fillets is attached to the second of the walls being relatively small such that cooling air is directed to the second of the walls.

The present disclosure may include any one or more of the individual features disclosed above and/or below alone or in any combination thereof.

These and other features of the present invention can be best understood from the following specification and drawings, the following of which is a brief description.

### BRIEF DESCRIPTION OF THE DRAWINGS

FIG. 1 schematically shows a gas turbine engine.

FIG. 2A schematically shows a turbine blade.

FIG. 2B shows a detail of a cooling passage within the FIG. 2A turbine blade.

FIG. 3A shows a stator vane.

FIG. 3B shows a blade outer air seal.

FIG. 4A shows a prior art heat transfer member.

FIG. 4B shows a detail of the FIG. 4A member.

FIG. 5A shows a first embodiment of this disclosure.

FIG. 5B shows a shows a detail of the FIG. 5A embodiment.

FIG. 6A shows a second embodiment.

FIG. 6B shows details of the FIG. 6A embodiment.

FIG. 7A shows yet another embodiment.

FIG. 7B shows details of the FIG. 7A embodiment.

FIG. 8A shows a further embodiment.

FIG. 8B shows details of the FIG. 8A embodiment.

FIG. 9A shows a further embodiment.

FIG. 9B shows a detail of the FIG. 9A embodiment.

FIG. 10A shows a further embodiment.

FIG. 10B shows details of the FIG. 10A embodiment.

FIG. 11A shows a further alternative embodiment.

FIG. 11B shows yet another embodiment.

FIG. 12 shows another detail.

### DETAILED DESCRIPTION

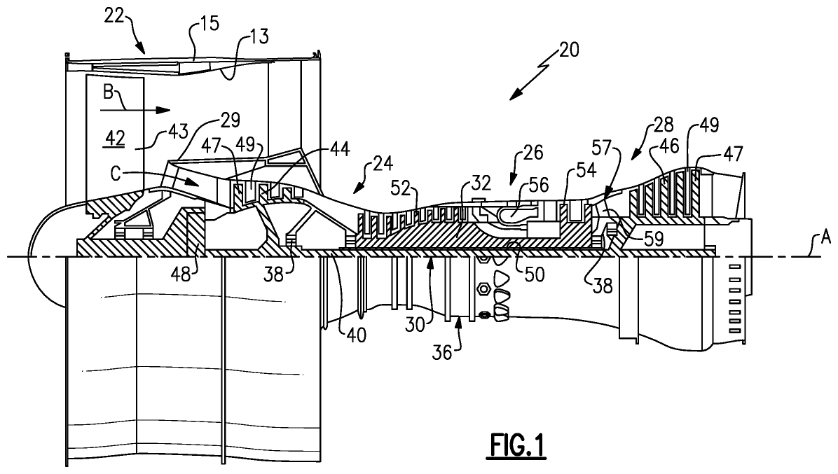

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. The fan section 22 may include a single-stage fan 42 having a plurality of fan blades 43. The fan blades 43 may have a fixed stagger angle or may have a variable pitch to direct incoming airflow from an engine inlet. The fan 42 drives air along a bypass flow path B in a bypass duct 13 defined within a housing 15 such as a fan case or nacelle, and also drives air along a core flow path C for compression and communication into the combustor section 26 then expansion through the turbine section 28. A splitter 29 aft of the fan 42 divides the air between the bypass flow path B and the core flow path C. The housing 15 may surround the fan 42 to establish an outer diameter of the bypass duct 13. The splitter 29 may establish an inner diameter of the bypass duct 13. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures. The engine 20 may incorporate a variable area nozzle for varying an exit area of the bypass flow path B and/or a thrust reverser for generating reverse thrust.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects, a first (or low) pressure compressor 44 and a first (or low) pressure turbine 46. The inner shaft 40 is connected to the fan 42 through a speed change mechanism, which in the exemplary gas turbine engine 20 is illustrated as a geared architecture 48 to drive the fan 42 at a lower speed than the low speed spool 30. The inner shaft 40 may interconnect the low pressure compressor 44 and low pressure turbine 46 such that the low pressure compressor 44 and low pressure turbine 46 are rotatable at a common speed and in a common direction. In other embodiments, the low pressure turbine 46 drives both the fan 42 and low pressure compressor 44 through the geared architecture 48 such that the fan 42 and low pressure compressor 44 are rotatable at a common speed. Although this application discloses geared architecture 48, its teaching may benefit direct drive engines having no geared architecture. The high speed spool 32 includes an outer shaft 50 that interconnects a second (or high) pressure compressor 52 and a second (or high) pressure turbine 54. A combustor 56 is arranged in the exemplary gas turbine 20 between the high pressure compressor 52 and the high pressure turbine 54. A mid-turbine frame 57 of the engine static structure 36 may be arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

Airflow in the core flow path C is compressed by the low pressure compressor 44 then the high pressure compressor 52, mixed and burned with fuel in the combustor 56, then expanded through the high pressure turbine 54 and low pressure turbine 46. The mid-turbine frame 57 includes airfoils 59 which are in the core flow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of the low pressure compressor, or aft of the combustor section 26 or even aft of turbine section 28, and fan 42 may be positioned forward or aft of the location of gear system 48.

The low pressure compressor 44, high pressure compressor 52, high pressure turbine 54 and low pressure turbine 46 each include one or more stages having a row of rotatable airfoils. Each stage may include a row of vanes adjacent the rotatable airfoils. The rotatable airfoils are schematically indicated at 47, and the vanes are schematically indicated at 49.

The engine 20 may be a high-bypass geared aircraft engine. The bypass ratio can be greater than or equal to 10.0 and less than or equal to about 18.0, or more narrowly can be less than or equal to 16.0. The geared architecture 48 may be an epicyclic gear train, such as a planetary gear system or a star gear system. The epicyclic gear train may include a sun gear, a ring gear, a plurality of intermediate gears meshing with the sun gear and ring gear, and a carrier that supports the intermediate gears. The sun gear may provide an input to the gear train. The ring gear (e.g., star gear system) or carrier (e.g., planetary gear system) may provide an output of the gear train to drive the fan 42. A gear reduction ratio may be greater than or equal to 2.3, or more narrowly greater than or equal to 3.0, and in some embodiments the gear reduction ratio is greater than or equal to 3.4. The gear reduction ratio may be less than or equal to 4.0. The fan diameter is significantly larger than that of the low pressure compressor 44. The low pressure turbine 46 can have a pressure ratio that is greater than or equal to 8.0 and in some embodiments is greater than or equal to 10.0. The low pressure turbine pressure ratio can be less than or equal to 13.0, or more narrowly less than or equal to 12.0. Low pressure turbine 46 pressure ratio is pressure measured prior to an inlet of low pressure turbine 46 as related to the pressure at the outlet of the low pressure turbine 46 prior to an exhaust nozzle. It should be understood, however, that the above parameters are only exemplary of one embodiment of a geared architecture engine and that the present invention is applicable to other gas turbine engines including direct drive turbofans. All of these parameters are measured at the cruise condition described below.

A significant amount of thrust is provided by the bypass flow B due to the high bypass ratio. The fan section 22 of the engine 20 is designed for a particular flight condition—typically cruise at about 0.8 Mach and about 35,000 feet (10,668 meters). The flight condition of 0.8 Mach and 35,000 ft (10,668 meters), with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. The engine parameters described above, and those in the next paragraph are measured at this condition unless otherwise specified.

“Fan pressure ratio” is the pressure ratio across the fan blade 43 alone, without a Fan Exit Guide Vane (“FEGV”) system. A distance is established in a radial direction between the inner and outer diameters of the bypass duct 13 at an axial position corresponding to a leading edge of the splitter 29 relative to the engine central longitudinal axis A. The fan pressure ratio is a spanwise average of the pressure ratios measured across the fan blade 43 alone over radial positions corresponding to the distance. The fan pressure ratio can be less than or equal to 1.45, or more narrowly greater than or equal to 1.25, such as between 1.30 and 1.40. “Corrected fan tip speed” is the actual fan tip speed in ft/sec divided by an industry standard temperature correction of [(Tram ° R)/(518.7° R)]^{0.5}. The corrected fan tip speed can be less than or equal to 1150.0 ft/second (350.5 meters/second), and can be greater than or equal to 1000.0 ft/second (304.8 meters/second).

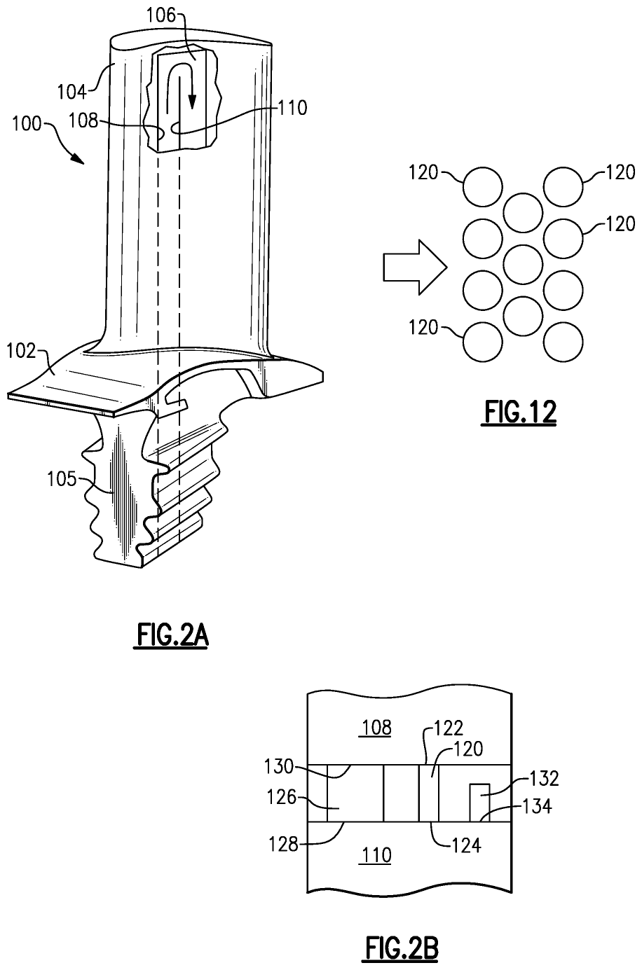

As mentioned above, components in the turbine section see very high temperatures and are typically provided with cooling air. An example rotating turbine blade 100 is illustrated in FIG. 2A. Turbine blade 100 has a platform 102 and an airfoil 104 extending from the platform 102. There is also mounting structure 105. A cooling chamber 106 is shown schematically which will be within the airfoil 104. The cooling channel 106 is serpentine and has spaced walls 108 and 110. Cooling chambers may also be provided in platform 102.

FIG. 2B shows heat transfer enhancement members which are positioned between the walls 108 and 110. In one example, a pedestal 120 extends from an end 124 attached to wall 110 and to an end 122 at the wall 108. As will be explained below, each of the ends 124 and 122 are formed with a fillet for manufacturing purposes and to provide strength to the overall member 120.

A so called race track 126, which is essentially an oval shaped pedestal, extends between ends 128 and 130 attached to walls 110 and 108, respectively. Here again, there will typically be fillets at the ends 128 and 130. A pin fin 132 extends from wall 110 towards wall 108 but does not reach wall 108. An end 134 is provided with a fillet.

FIG. 3A schematically shows a stator vane 140 having an airfoil 144 extending between platforms 142 and 146. Similar to the turbine blade of FIG. 2A there is an internal cooling circuit 145, shown schematically.

FIG. 3B shows a blade outer air seal 150 having a seal portion 152 with a radially inner face 154 spaced from a radially outer tip 156 of a rotating turbine blade 157. Here again, there is an internal cooling path 153 shown schematically.

The cooling paths 145 and 143 will include heat transfer members such as described with regard to FIG. 2B.

FIG. 4A shows a prior art pedestal 158. Pedestal 158 has a central portion 160 and a fillet 162 at hot wall 108 and a fillet 163 at hot wall 110.

As shown in FIG. 4B, the central portion 160 is generally centered in the fillet 162. The central portion 160 is also centered in the fillet 163. The fillets 162 and 163 are each generally symmetric and are each generally identical to each other.

Returning to FIG. 4A, one can see the direction of the cooling airflow does not change by the symmetric fillets.

Applicant has recognized that by modifying the fillets to be asymmetric one can control the direction of cooling airflow across the pedestals. The fillets can also be maximized to increase a cold side surface area to increase heat transfer. The same would be true of race tracks or pin fins such as shown in FIGS. 3A and 3B.

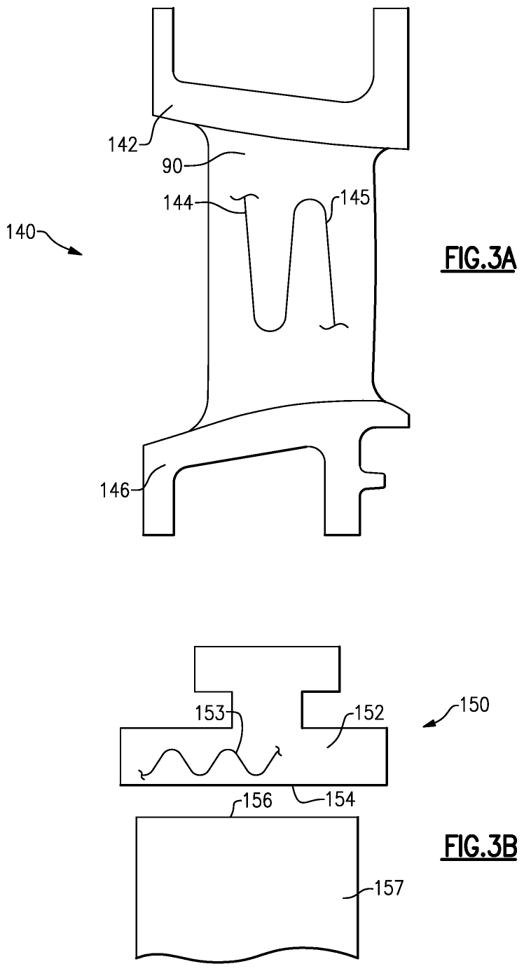

A first embodiment 200 according to this disclosure is illustrated in FIG. 5A. In embodiment 200, a central portion 202 may be generally cylindrical. However, the fillets are asymmetric with an enlarged fillet portion 204 at a leading edge of the fillet attached to the wall 108 and a smaller fillet 206 at a trailing edge. The leading edge 208 of the other fillet attached to the wall 110 is also large compared to the fillet 210 attached at the trailing edge to the wall 110.

As shown, this arrangement will direct cooling air associated with the fillets in a direction toward the walls 108 and 110.

As shown in FIG. 5B, the fillets are asymmetric with the central portion 202 positioned closer to the trailing edge fillet 206 and spaced away from the larger leading edge fillet 204. Thus, there is an area 220 at the leading edge of the central portion 202 which is larger than a trailing edge area 212 of the distance between the central portion 202 and the end of the fillet. The same is true at both ends as shown in the two figures.

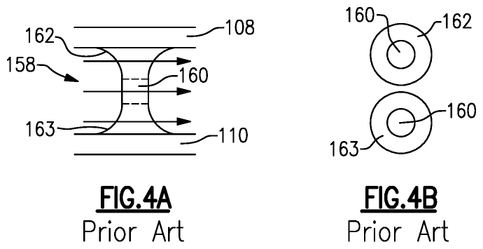

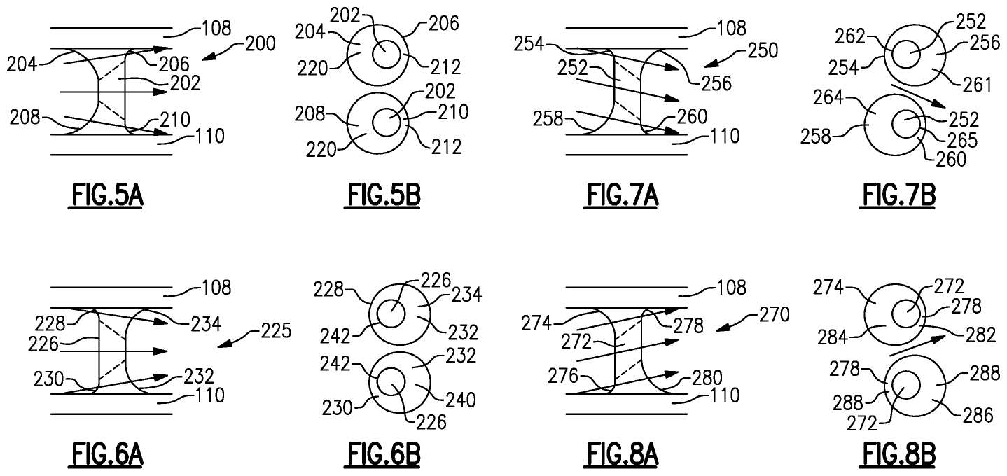

FIG. 6A shows an embodiment 225 wherein the central portion 226 is again cylindrical. The leading edge fillet 228 is now small compared to the trailing edge fillet 234 at the wall 108. Similarly, the leading edge fillet 230 is small compared to the trailing edge fillet 232 at the wall 110.

As shown in FIG. 6A, this results in the cooling airflow being directed inwardly and away from both walls 108 and 110.

As shown in FIG. 6B, in the embodiment 225, there is less area 242 between the leading edge 228 of the fillet and the end of central portion 226 compared to the area 232 between the trailing edge 234 and the central portion 226. This is true at both the walls 108 and the wall 110.

As shown in FIG. 7A, in embodiment 250, the central portion 252 is provided with a leading edge fillet portion 254 which is relatively small compared to the trailing edge fillet portion 256 attached to wall 108. Conversely, there is a large fillet portion 258 at the leading edge and a smaller fillet portion 260 at the trailing edge attached to wall 110. This directs the cooling air towards the wall 110.

As shown in FIG. 7B, a central portion 252 now has a relatively small area 262 associated with the leading edge fillet 254 and a relatively large area 261 associated with the trailing edge fillet portion 256. Conversely, there is a relatively large area 264 between the central portion 252 and the leading edge fillet portion 258 compared to the area 265 associated with the trailing edge fillet portion 260.

FIG. 8A shows an embodiment 270 wherein the central portion 272 is again cylindrical. The leading edge fillet portion 274 is large at the fillet attached to wall 108, whereas the trailing edge fillet portion 278 is relatively small. Conversely, the leading edge portion 276 of the fillet attached to wall 110 is small compared to the trailing edge fillet portion 280 attached to the wall 110. As shown, this directs the cooling air toward the wall 108.

As shown in FIG. 8B, the central portion 272 at the wall 108 has an enlarged area 284 associated with the fillet 274 compared to a relatively small area 282 associated with the trailing edge fillet 278. Conversely, there is a relatively small area 288 between the central portion 272 and the leading edge fillet portion 276 at wall 110 compared to the area 286 provided by the trailing edge fillet portion 280.

FIG. 9A shows a race track pedestal 290 wherein the race track heat pedestal 290 has a central portion 294 and with leading edge fillets 292 attached to walls 108 and 110 which are relatively large compared to trailing edge fillets 296. While one of the several options shown in the FIGS. 5-8 are utilized here, each of those variations could be utilized with this race track embodiment.

As shown in FIG. 9B, with the embodiment the central portion 294 is relatively close to the edge of the fillet 296 and relatively far from the edge of the leading edge fillet 292.

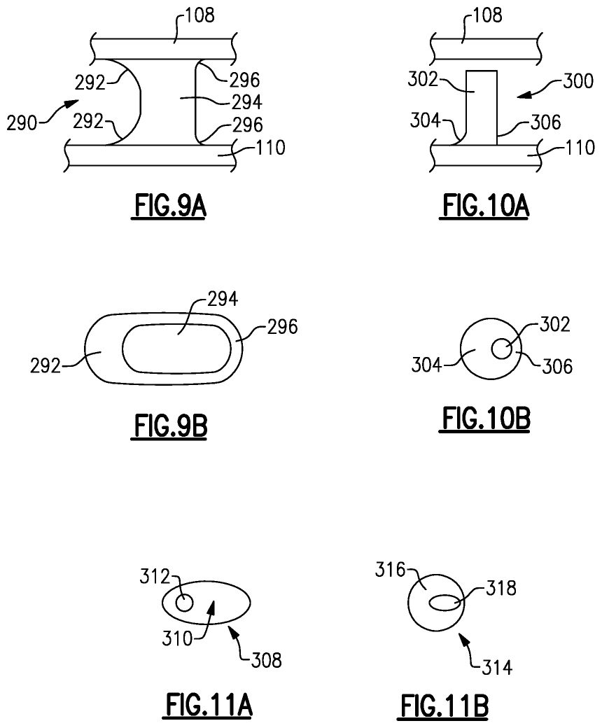

FIG. 10A shows an embodiment 300 wherein the heat transfer member is a pin fin 300. Pin fin 300 is attached to wall 110 through a fillet having an enlarged leading edge portion 304 and a smaller trailing edge 306.

As shown in FIG. 10B, the central portion 302 is close to the edge of the trailing edge portion 306 and spaced further from the edge of the leading edge portion 304.

Similar to the FIGS. 9A and 9B embodiment, any of the other options shown in FIGS. 5-8 could be utilized with this embodiment.

While the heat transfer members have been shown having central portions and fillets with generally the same geometric shape, there may be variation between the two shapes. As an example, in FIG. 11A, an embodiment 308 is shown wherein the fillet 310 is generally race trace shape while the central portion 312 is generally cylindrical.

Conversely, in FIG. 11B, an embodiment 314 has a fillet 316 which is cylindrical and a central portion 318 which is race track shaped. Any number of other shapes may be utilized.

FIG. 12 shows that the pedestals 120 are generally arranged in an array of a plurality of pedestals. Cooling air flows across the pedestal and enhances the cooling effect of the cooling air by increasing surface airflow in contact with the cooling air. The fillet shape may be selected to direct airflow at downstream pedestals.

Workers of skill in this art would recognize that by utilizing any number of possible combinations one can direct cooling air at an area that desirably receives more cooling air.

A gas turbine engine component under this disclosure could be said to include a body having an internal cooling passage with opposed walls and an array of heat transfer members attached to at least one of the opposed walls each with at least one fillet. There is an airflow direction through the cooling cavity such that the heat transfer members have a leading edge and a trailing edge. The at least one fillets have a leading edge and a trailing edge. A fillet portion leading edge is asymmetric relative to a fillet portion trailing edge to control an air flow direction towards downstream ones of the heat transfer members in the array.

A gas turbine engine component under this disclosure could also be said to include a body having an internal cooling passage with opposed walls and a heat transfer member attached to at least one of the opposed walls at a fillet. There is an airflow direction through the cooling cavity such that the heat transfer member has a leading edge and a trailing edge. The at least one fillet has a leading edge and a trailing edge. A fillet portion leading edge is asymmetric relative to a fillet portion trailing edge. The heat transfer components are attached to each of the spaced walls and there are two of the at least one fillets. Each of the two fillets having a leading edge portion which is asymmetric from a trailing edge portion. The two fillets are asymmetric relative to each other. The heat transfer components have a leading edge of one of the at least two fillets attached to one of the at least two walls being small and a leading edge fillet portion of the other of the fillets is attached to a second of the walls being relatively large. A trailing edge portion of the fillet attached to the first of the walls being relatively large and a trailing edge portion of the second of the fillets is attached to the second of the walls being relatively small such that cooling air is directed to the second of the walls.

A gas turbine engine under this disclosure could be said to include a compressor section delivering compressed air into a combustor. The combustor is configured to mix fuel with compressed air and ignite the mixture. Products of the combustion are configured to pass over a turbine section. The turbine section includes a plurality of components with at least one of the components being provided. A gas turbine engine component includes a body having an internal cooling passage with opposed walls and an array of heat transfer members attached to at least one of the opposed walls each with at least one fillet. There is an airflow direction through the cooling cavity such that the heat transfer members have a leading edge and a trailing edge. The at least one fillets have a leading edge and a trailing edge. A fillet portion leading edge is asymmetric relative to a fillet portion trailing edge to control an air flow direction towards downstream ones of the heat transfer member in the array.

While embodiments have been disclosed, a worker of ordinary skill in this art would recognize that modification would come within the scope of this disclosure. For that reason the following claims should be studied to determine the true scope and content of this disclosure.

What is claimed is:

1. A gas turbine engine component comprising:
a body having an internal cooling passage with opposed walls and an array of heat transfer members attached to at least one of said opposed walls each with at least one fillet, and there being an airflow direction through said cooling cavity such that said heat transfer members have a leading edge and a trailing edge, and said at least one fillets having a leading edge and a trailing edge, and a fillet portion leading edge being asymmetric relative to a fillet portion trailing edge to control an air flow direction towards downstream ones of said heat transfer members in said array.

2. The gas turbine engine component as set forth in claim 1, wherein said fillet portion leading edge is relatively large compared to said fillet portion trailing edge.

3. The gas turbine engine component as set forth in claim 1, wherein said fillet portion leading edge is small compared to said fillet portion trailing edge.

4. The gas turbine engine component as set forth in claim 1, wherein said heat transfer components are attached to each of said spaced walls and there are two of said at least one fillets, and each of said two fillets having a leading edge portion which is asymmetric from a trailing edge portion.

5. The gas turbine engine component as set forth in claim 4, wherein said heat transfer members have a central portion intermediate said at least two fillets, and said central portion having a similar cross-sectional shape to a cross-sectional shape of each of said two fillet portions.

6. The gas turbine engine component as set forth in claim 4, wherein said heat transfer members have a central portion intermediate said two fillets, and said central portion and said fillet portions have distinct cross-sectional shapes.

7. The gas turbine engine component as set forth in claim 4, wherein said two fillets are asymmetric relative to each other.

8. The gas turbine engine component as set forth in claim 7, wherein said heat transfer components have a leading edge of one of said at least two fillets attached to one of said at least two walls being small and a leading edge fillet portion of the other of said fillets attached to a second of said walls being relatively large, and a trailing edge portion of said fillet attached to the first of said walls being relatively large and a trailing edge portion of the second of said fillets attached to the second of said walls being relatively small such that cooling air is directed to the second of said walls.

9. The gas turbine engine component as set forth in claim 1, wherein the component is a rotating turbine blade.

10. The gas turbine engine component as set forth in claim 1, wherein the component is a static stator vane.

11. The gas turbine engine component as set forth in claim 1, where the component is a blade outer air seal.

12. The gas turbine engine component as set forth in claim 1, wherein the heat transfer member is a pedestal having a cylindrical central section.

13. The gas turbine engine component as set forth in claim 1, wherein the heat transfer component has a central portion which is generally oval.

14. The gas turbine engine component as set forth in claim 1, wherein the heat transfer component is a pin fin attached to only one of said at least two wall through only one fillet.

15. A gas turbine engine component comprising:
a body having an internal cooling passage with opposed walls and a heat transfer member attached to at least one of said opposed walls at a fillet, and there being an airflow direction through said cooling cavity such that said heat transfer member has a leading edge and a trailing edge, and said at least one fillet having a leading edge and a trailing edge, and a fillet portion leading edge being asymmetric relative to a fillet portion trailing edge;
wherein said heat transfer components are attached to each of said spaced walls and there are two of said at least one fillets, and each of said two fillets having a leading edge portion which is asymmetric from a trailing edge portion;
wherein said two fillets are asymmetric relative to each other; and
wherein said heat transfer components have a leading edge of one of said at least two fillets attached to one of said at least two walls being small and a leading edge fillet portion of the other of said fillets attached to a second of said walls being relatively large, and a trailing edge portion of said fillet attached to the first of said walls being relatively large and a trailing edge portion of the second of said fillets attached to the second of said walls being relatively small such that cooling air is directed to the second of said walls.

16. The gas turbine engine component as set forth in claim 15, wherein said heat transfer members have a central portion intermediate said at least two fillets, and said central portion having a similar cross-sectional shape to a cross-sectional shape of each of said two fillet portions.

17. The gas turbine engine component as set forth in claim 15, wherein said heat transfer members have a central portion intermediate said two fillets, and said control portion and said fillet portions have distinct cross-sectional shapes.

18. A gas turbine engine comprising:
a compressor section delivering compressed air into a combustor, and the combustor being configured to mix fuel with compressed air and ignite the mixture, and products of the combustion being configured to pass over a turbine section, the turbine section comprising a plurality of components with at least one of the components being provided;
a gas turbine engine component comprising:
a body having an internal cooling passage with opposed walls and an array of heat transfer members attached to at least one of said opposed walls each with at least one fillet, and there being an airflow direction through said cooling cavity such that said heat transfer members have a leading edge and a trailing edge, and said at least one fillets having a leading edge and a trailing edge, and a fillet portion leading edge being asymmetric relative to a fillet portion trailing edge to control an air flow direction towards downstream ones of said heat transfer members in said array.

19. The gas turbine engine component as set forth in claim 18, wherein said heat transfer components are attached to each of said spaced walls and there are two of said at least one fillets, and each of said two fillets having a leading edge portion which is asymmetric from a trailing edge portion, wherein said two fillets are asymmetric relative to each other.

20. The gas turbine engine component as set forth in claim 7, wherein said heat transfer components have a leading edge of one of said at least two fillets attached to one of said at least two walls being small and a leading edge fillet portion of the other of said fillets attached to a second of said walls being relatively large, and a trailing edge portion of said fillet attached to the first of said walls being relatively large and a trailing edge portion of the second of said fillets attached to the second of said walls being relatively small such that cooling air is directed to the second of said walls
